(19) United States
(12) Patent Application Publication
(10) Pub. No.: US 2011/0122184 A1
(43) Pub. Date: May 26, 2011

(54) Image forming apparatus, image formation method, and computer-readable medium

(75) Inventors: Tomonori Kimura, Kanagawa-ken (JP); Yasuo Sakurai, Kanagawa-ken (JP); Yuichi Sakurada, Kanagawa-ken (JP); Arata Suzuki, Kanagawa-ken (JP)

(73) Assignee: Ricoh Company, Ltd.

(21) Appl. No.: 12/926,486

(22) Filed: Nov. 22, 2010

(30) Foreign Application Priority Data
Nov. 24, 2009 (JP) 2009-266332
Apr. 19, 2010 (JP) 2010-095941

(51) Int. Cl. B41J 2/07

(52) U.S. Cl. 347/14

(57) ABSTRACT

An image forming apparatus including a first carriage having a print head independently movable in a main scanning direction, a second carriage having a print head movable with the first carriage, an encoder sheet, first and second home position reference units provided to the first and second carriages, a home position detector that detects the first and second home position reference units, and first and second position detectors provided to the first and second carriages, which detect positions of the first and second carriages by reading the encoder sheet. A control unit controls ejection of ink from the print head of the first carriage based on an output from the first position detector, and ejection of ink from the print head of the second carriage based on the output from the second position detector.

### BACKGROUND OF THE INVENTION

1. Field of the Invention

The present invention relates to an image forming apparatus, and more particularly to an ink jet image forming apparatus.

2. Discussion of the Background

Among image forming apparatuses such as printers, facsimile machines, photocopying machines, and multi-function machines thereof, there is an image faulting apparatus employing an ink jet system using a liquid ejection head that ejects droplets of recording liquid (i.e., ink) onto a transfer medium for image formation.

For example, in a printer employing a color ink jet system, images are printed by scanning by a carriage having liquid ejection heads (also referred to as a recording head, print head, or head) or heads having nozzle arrays for black (K), yellow (Y), cyan (C), and magenta (M) ink.

However, when monochrome images are printed in such color printers, the printing surfaces of the other multiple color heads which are not used for the monochrome printing are exposed to the atmosphere, causing clogging due to adhesion of dried ink or impurities to the print heads and thereby preventing the color print heads from ejecting ink properly when color images are printed after the monochrome printing.

Therefore, the color print heads have to be cleaned, which means such things as maintenance ejection of the color ink is required for the other multiple color print heads even when monochrome images are printed. However, this cleaning does consume ink. In addition, electricity is wasted and printing time is unnecessarily increasing. Furthermore, when the cleaning is insufficient, the ink is not properly ejected, resulting in degradation of image quality.

To deal with these problems, for example, Japanese patent application publication no. H02-1327-A describes a system having a first carriage for color print heads and a second carriage for monochrome print heads. The two carriages are combined by a binding mechanism for scanning and printing when printing color images. Only the second carriage scans and prints images when printing monochrome images in order to prevent the print heads on the first carriage from being exposed and drying out.

However, in the approach described in H02-1327-A two separate carriages are detachably attachable to each other, and combined as needed to scan and print images. Therefore, misalignment of the two carriages may occur, leading to degradation of image quality. Despite this problem, however, H02-1327-A does not discuss either the misalignment of the combined carriages or any solution thereto.

### SUMMARY OF THE INVENTION

For these reasons, the present inventors recognize that a need exists for an image forming apparatus that has a structure of two carriages detachably attachable to each other without misalignment to reliably provide printed images of consistently high quality.

Accordingly, an object of the present invention is to provide an image forming apparatus that has a structure of two carriages detachably attachable to each other without misalignment to reliably provide printed images of consistently high quality.

Briefly, this and other objects of the present invention as hereinafter described will become more readily apparent and can be attained, either individually or in combination thereof, by an image forming apparatus including a first carriage having a print head that is independently movable in a main scanning direction, a second carriage having a print head integrally movable in the main scanning direction together with the first carriage, an encoder sheet for detecting positions of the first carriage and the second carriage in the main scanning direction, a first home position reference unit provided to the first carriage, a second home position reference unit provided to the second carriage, a home position detector that detects the first home position reference unit and the second home position reference unit, a first position detector provided to the first carriage that detects a position of the first carriage by reading the encoder sheet, a second position detector provided to the second carriage that detects a position of the second carriage by reading the encoder sheet, and a control unit including a central processing unit that controls ejection of ink from the print head of the first carriage based on an output from the first position detector when the home position detector detects the first home position reference unit, and ejection of ink from the print head of the second carriage based on the output from the second position detector when the home position detector detects the second home position reference unit.

It is preferred that, in the image forming apparatus described above, when images are printed by singly moving the first carriage, the first carriage and the second carriage are coupled together and pressed against a stopper provided on a lateral side of the apparatus until outputs of the first position detector and the second position detector are unchanged, and thereafter the outputs of the first position detector and the second position detector are reset, the first carriage is singly moved to a printable area, and a printing position of the first carriage is initialized when the home position detector detects the first home position reference unit.

It is still further preferred that, in the image forming apparatus described above, when images are printed by integrally moving the first carriage and the second carriage together, the first carriage and the second carriage are coupled together and pressed against a stopper provided on a lateral side of the apparatus until outputs of the first position detector and the second position detector are unchanged, thereafter the outputs of the first position detector and the second position detector are reset, the first carriage and the second carriage are integrally moved to a printable area, a printing position of the first carriage is initialized when the home position detector detects the first home position reference unit, and a printing position of the second carriage is initialized when the home position detector detects the second home position reference unit.

It is still further preferred that, in the image forming apparatus described above, one of the first carriage and the second carriage further includes a relative position encoder sheet that detects a position in the main scanning direction, and the other of the first carriage and the second carriage further includes a third position detector that reads the relative position of the encoder sheet, and wherein a relative tilt between the first carriage and the second carriage is detected based on outputs of the first position detector, the second position detector, and the third position detector.

It is still further preferred that, in the image forming apparatus described above, printing positions are corrected based on the relative tilt between the first carriage and the second carriage.

As another aspect of the present invention, an image formation method is provided which includes moving a first carriage having a print head in a main scanning direction, moving a second carriage having a print head integrally in the main scanning direction together with the first carriage, detecting the positions of the first carriage and the second carriage in the main scanning direction by reading an encoder sheet by a first position detector provided to the first carriage, and a second position detector provided to the second carriage, respectively, detecting a first home position reference unit provided to the first carriage and a second home position reference unit provided to the second carriage by a home position detector and controlling ejection of ink from the print head of the first carriage based on an output from the first position detector when the home position detector detects the first home position reference unit and ejection of ink from the print head of the second carriage based on an output from the second position detector when the home position detector detects the second home position reference unit by control unit including a central processing unit.

As another aspect of the present invention, a computer-readable recording medium storing a computer program for executing a control method for a recording device is provided, the control method including moving a first carriage comprising a print head in a main scanning direction;

moving a second carriage comprising a print head integrally in the main scanning direction together with the first carriage;

detecting positions of the first carriage and the second carriage in the main scanning direction by reading an encoder sheet by a first position detector provided to the first carriage, and a second position detector provided to the second carriage, respectively;

detecting a first home position reference unit provided to the first carriage and a second home position reference unit provided to the second carriage by a home position detector; and

controlling ejection of ink from the print head of the first carriage based on an output from the first position detector when the home position detector detects the first home position reference unit and ejection of ink from the print head of the second carriage based on an output from the second position detector when the home position detector detects the second home position reference unit by control unit comprising a central processing unit.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating the mechanism part of an embodiment of the image forming apparatus of the present disclosure;

FIG. 2 is a schematic diagram illustrating a first carriage and a second carriage connected by a lock mechanism;

FIG. 3 is a function block diagram of a control unit of an embodiment of the image forming apparatus of the present disclosure;

FIG. 4 is a schematic diagram illustrating a typical integrated carriage;

FIG. 5 is a diagram illustrating the combined state of the first and the second carriages;

FIG. 6 is a flow chart illustrating the start of printing in the printing processing;

FIG. 7 is a schematic diagram illustrating the image forming apparatus of the present disclosure when printing monochrome images;

FIG. 8 is a schematic diagram illustrating the image forming apparatus of the present disclosure when printing color images;

FIG. 9 is a schematic diagram illustrating another embodiment of the mechanism part of the image forming apparatus of the present disclosure;

FIG. 10 in is a function block diagram of a control unit of another embodiment of the image forming apparatus of the present disclosure;

FIG. 11 is a flow chart of an example of the printing process;

FIG. 12 is a diagram illustrating a process of calculating tilt; and

FIG. 13 is another diagram illustrating a process of calculating tilt.

### DETAILED DESCRIPTION OF THE PRESENT DISCLOSURE

The structure of embodiments of the present disclosure is described with reference to the accompanied drawings. In this specification, the term “medium” is not limited to paper, and may be also referred to as a recording medium, transfer material, or recording paper. In addition, the term “image formation” includes recording, printing, and imaging.

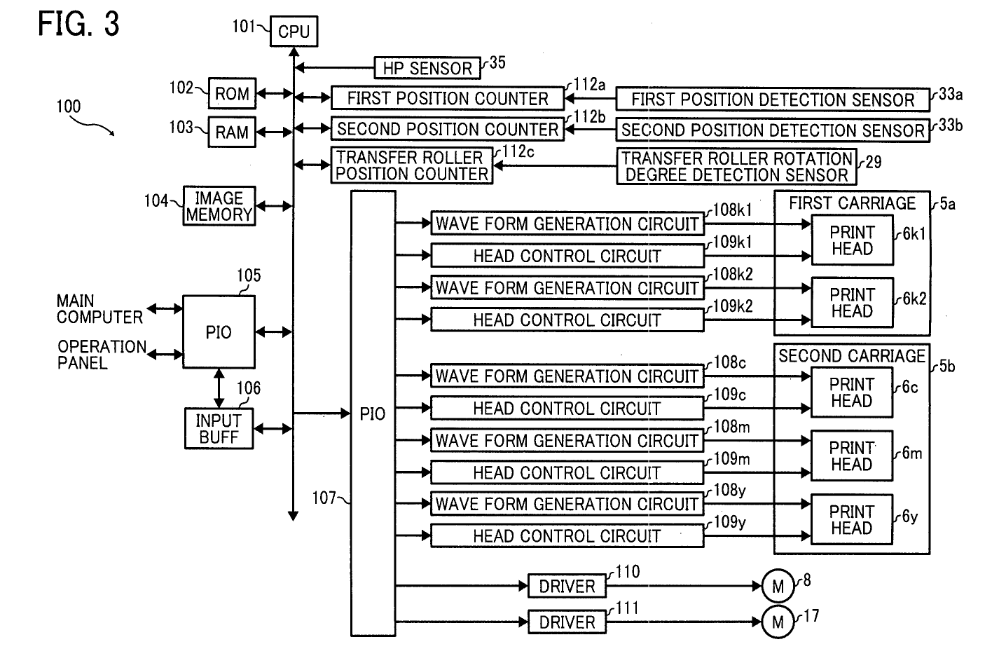

In sum, the image forming apparatus of the present disclosure includes a first carriage 5a independently movable in a main scanning direction, and a second carriage integrally movable in the main scanning direction together with the first carriage 5a. In addition, the image forming apparatus further includes an encoder sheet 32 that is used to detect the positions of the first carriage 5a and the second carriage 5b in the main scanning direction, a first home position reference unit (closure plate 34a) that is attached to the first carriage 5a, a second home position reference unit (closure plate 34b) that is attached to the second carriage 5b, a home position detector (home position sensor 35) that detects the first home position reference unit and the second home position reference unit, a first position detector (first position detection sensor 33a and a first position counter 112a) that is provided to the first carriage 5a to detect the position of the first carriage 5a by reading the encoder sheet 32, and a second position detector (second position detection sensor 33b and a second position counter 112b) that is provided to the second carriage 5b to detect the position of the second carriage 5b by reading the encoder sheet 32. A control unit 100 (shown in functional block form in FIG. 3) in the image forming apparatus controls ink ejection from the print head installed onto the first carriage 5a based on the output from the first position detector when the home position detector detects the first home position reference unit, and from the print head installed onto the second carriage 5b based on the output from the second position detector when the home position detector detects the second home position reference unit.

A description is now given of specific embodiments of the present invention.

### First Embodiment

### Structure of the Image Forming Apparatus

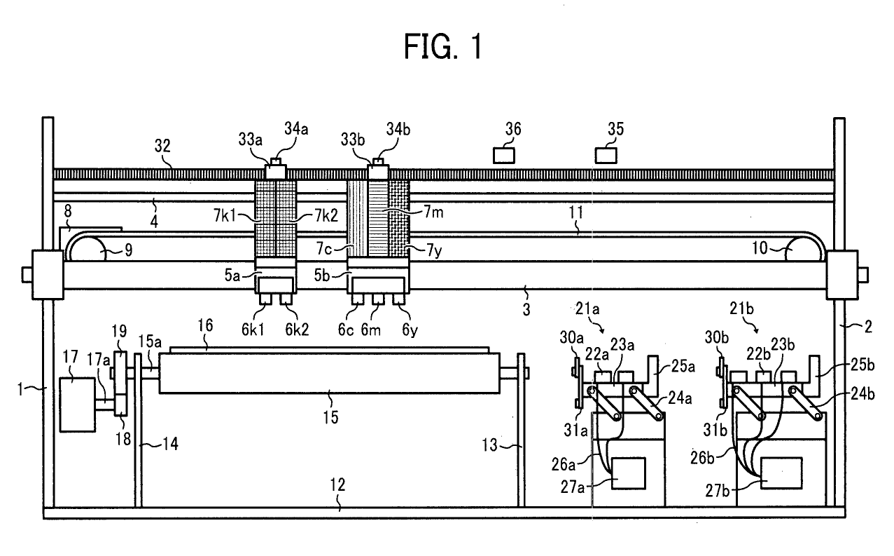

FIG. 1 is a schematic structure view illustrating the mechanism portion of the ink jet recording apparatus.

In the mechanism of this ink jet recording apparatus, a main support guide rod 3 and a sub-support guide rod 4 extend substantially horizontal to each other between side plates (left side plate 1 and right side plate 2) situated on both sides to support the first carriage 5a for monochrome printing and the second carriage 5b for color printing, such that the two carriages can slidably move along the rods in the main scanning direction. In this embodiment, the right side plate 2 is used as a stopper against which the carriages are pressed. In addition, the encoder sheet 32 for position detection is provided all over the entire movable area of the first carriage 5a and the second carriage 5b between the side plates 1 and 2. In this embodiment, the encoder sheet 32 is a sheet having a stripe pattern with a unit corresponding to the print resolution. However, the encoder sheet 32 is not limited thereto, and any known or new encoder sheet can be used.

In addition, any known method can be used for the sensor control to obtain the position information by reading the encoder sheet, and thus a description of such methods is omitted.

The first carriage 5a includes two print heads 6k1 and 6k2 that eject black ink, with their ejection surfaces (nozzle surfaces) downward. In addition, the first carriage 5a has replaceable ink cartridges 7k1 and 7k2 as ink suppliers to supply ink to the print heads 6k1 and 6k2, respectively, above a print head 6a for monochrome printing. In this specification, the print head 6a is used to indicate the print heads 6k1 and 6k2 when the latter are referred to collectively.

The first carriage 5a further includes the first carriage sensor 33a that obtains the position information of the first carriage 5a by reading the encoder sheet 32, and the closure plate (first home position reference unit) 34a detected by the home position sensor 35 so that the control unit 100 detects the home position the first carriage 5a.

Although the home position reference unit in this embodiment is the closure plate 34a that is detected by the home position 35, the home position reference unit is not limited thereto. Alternatively, for example, a combination of a light-emitting unit provided to a carriage and a sensor having a light-receiving unit can be suitably used.

The second carriage 5b includes three print heads 6c, 6m, and 6y that eject cyan (C) ink, magenta (M) ink, and yellow (Y) ink, respectively, with their ejection surfaces (nozzle surfaces) downward. In addition, the second carriage 5b has three replaceable ink cartridges 7c, 7m, and 7y as ink suppliers to supply corresponding ink to the print heads 6c, 6m, and 6y, respectively provided above a print head 6b (=the print heads 6c, 6m, and 6y) for color printing.

The second carriage 5b further includes the second carriage sensor 33b that obtains the position information of the second carriage 5b by reading the encoder sheet 32, and the closure plate (second home position reference unit) 34b detected by the home position sensor 35 so that the control unit 100 detects the home position of the second carriage 5b.

The positions detected by the home position sensor 35 when the closure plates 34a and 34b provided to the first carriage 5a and the second carriage 5b, respectively, are detected are determined as the home positions of the respective carriages.

In addition, an entry sensor 36 of the printing area is provided at the boundary with the printing area in the main scanning direction to detect whether the carriages 5a and 5b are present in the printing area.

In this embodiment, the print head 6k1 is set as the reference head (monochrome reference head) marking the reference position of the first carriage 5a, and the print head 6c is set as the reference head (color reference head) marking the reference position of the second carriage 5b. The positional relationship (e.g., a distance) between the assembly position of the print head 6k1 and the encoder sheet 32 is determined as the same as the positional relationship (e.g., a distance) between the assembly position of the print head 6c and the encoder sheets 32.

In addition, the first carriage 5a is connected to a timing belt 11 suspended between a driving pulley (driving timing pulley) 9 rotated by a main scanning motor 8 and a idler pulley 10 to move the print head 6a of the first carriage 5a along the main scanning direction by controlling driving of the main scanning motor 8.

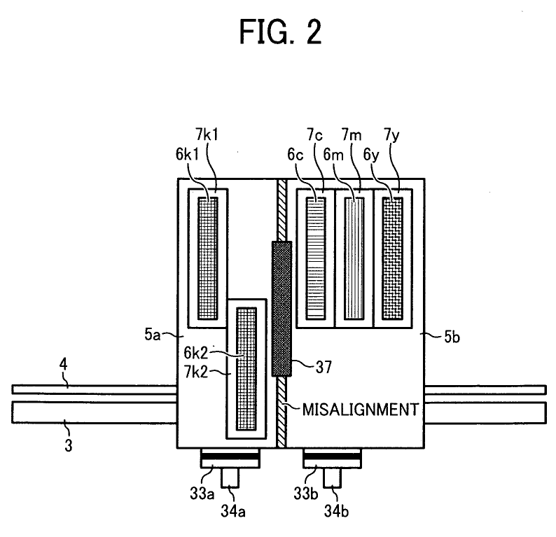

In addition, as illustrated in FIG. 2, the first carriage 5a and the second carriage 5b are coupled by a lock mechanism (linking device) 37. The print head 6b of the second carriage 5b moves in the main scanning direction driven by the first carriage 5a. There is no specific limit to the selection of the lock mechanism 37. For example, a linking lever and an engagement pin are suitable.

In addition, sub-frames 13 and 14 are vertically arranged on a base plate 12 that connects the side plates 1 and 2, and supports a transfer roller 15 that feeds a sheet 16 between the sub-frames 13 and 14 in a sub-scanning direction perpendicular to the main scanning direction by rotation.

A sub-scanning motor 17 is provided on the lateral side of the sub-frame 14. A gear 18 fixed to a rotation axis 17a of the sub-scanning motor 17 and a gear 19 fixed to an axis 15a of the transfer roller 15 are provided to transmit the torque from the sub-scanning motor 17 to the transfer roller 15.

Furthermore, a sub-system (also referred to as a cleaning device) 21a for the print head 6a for monochrome printing, and a sub-system 21b for the print head 6b for color printing are provided between the side plate 2 and the sub-frame 13.

The sub-system 21a of the print head 6a for monochrome printing has a holder 23a supporting two capping devices 22a that cap the ejection surface of the print head 6a. The holder 23a is supported by a link member 24a so as to swing back and forth. The first carriage 5a contacts an engaging portion 25a provided to the holder 23a when the first carriage 5a moves in the main scanning direction. Therefore, as the first carriage 5a moves in the main scanning direction, the holder 23a is lifted so that the ejection surface of the print head 6a is capped by the capping device 22a. As the first carriage 5a moves towards the printing area, the holder 23a lifts down so that the capping device 22a moves away from the ejection surface of the print head 6a.

The capping device 22a is connected to a suction pump 27a via a suction tube 26a, forms an air releasing opening and is communicated with atmosphere via an air releasing tube, and an air releasing valve.

In addition, the suction pump 27a discharges waste liquid (ink) suctioned by the suction pump 27a to a waste liquid tank through a drain tube, etc.

Furthermore, on the lateral side of the holder 23a, a wiper blade 30a serving as wiping device formed of an elastic material such as fiber, foamed material, and rubber that wipes the discharging surface of the print head 6a is attached to a blade arm 31a. The blade arm 31a is pivotally supported to swing back and forth by the rotation of cams rotated by a driving device (not shown).

The sub-system 21b for the print head 6b for color printing has the same structure as the subs-system 21a that includes three capping devices 22b that cap the ejection surface of the print head 6b, a holder 23b, a linking member 24b, an engaging portion 25b, a suction tube 26b, a suction pump 27b, a wiper blade 30b, and a blade arm 31b.

According to the image forming apparatus of the embodiment structured as described above, a monochrome image is recorded on the sheet 16 by ejecting ink droplets from each print head of 6k1 and 6k2 while moving the first carriage 5a having the print head 6a for scanning in the main scanning direction and simultaneously transferring the sheet 16 in the sub-scanning direction.

In the case of color printing, a color image is recorded on the sheet 16 by ejecting ink droplets from the nozzles of each print head of 6k1, 6k2, 6y, 6m, and 6c for required colors while moving the first carriage 5a coupled with the second carriage 6s having the print head 6b for color printing by the lock mechanism 37 for scanning in the main scanning direction and simultaneously transferring the sheet 16 in the sub-scanning direction.

Configuration of the Control Unit

FIG. 3 is a function block diagram illustrating a control system (control unit) 100 of the image forming apparatus of this embodiment.

The control unit 100 includes a microcomputer (CPU) 101 that exerts overall control of the image forming apparatus as the driving control device, a ROM 102 that stores certain predetermined, fixed data, a RAM used as a working memory, etc., an image memory 104 that stores processed image data transferred from the main computer, a parallel input output port (PIO) 105 that performs parallel input output from devices on the upstream side such as the main computer, an input buffer 106, a parallel input-output port (PIO) 107 that performs input and output to and from external devices on the downstream side, a waveform generation circuit 108 that generates a driving waveform required to drive analog elements of each print head, a head control circuit 109 that generates control signals to control each print head, a first motor driver 110 that drives the main scanning motor 8, and a second motor driver 111 that drives the sub-scanning motor 17 that drives the transfer roller 15 in the sub-scanning direction, and other driving power sources.

Various kinds of information, such as image data from the main computer, various kinds of instructions such as cleaning instructions from the operation panel, detection signals indicating detection of the front end and the rear end of a sheet from a sheet detection sensor, and signals from each kind of sensor such as the home position sensor 38 that senses the closure plate 34a of the first carriage 5a, are input to the parallel input output port 107. In addition, the parallel input output port 107 sends out required information to the main computer and the operation panel via the parallel input output port 105 on the upstream side.

In addition, a first carriage counter (first carriage position counter) 112a is provided that processes inputs of A phase of the first position detection sensor 33a provided to the first carriage 5a, and B phase having a phase 90 degree shifted from A phase, and detects the position of the first carriage 5a by a resolution power of quadrupled frequency relative to the resolution power of each phase.

Furthermore, there are also provided a second position counter (second carriage position counter) 112b having a similar function to the first position counter, and a transfer roller position counter 112c provided for a transfer roller rotation angle detection sensor 29 provided to the transfer roller 15.

The waveform generation circuit 108 generates and outputs a driving waveform that is applied to a piezoelectric element in the print head. In this embodiment, a D/A converter is used as the waveform generation circuit 108 to generate and output a first driving waveform to form large dots, a second driving waveform to form small dots, and a third driving waveform to form minute dots by D/A conversion of the voltage data provided from the CPU 101. In addition, since the waveform generation circuit 108k1, 108k2, 108c, 108m, and 108y (referred to collectively as waveform generation circuit 108) is provided for each print head, driving waveforms can be generated separately at a specific timing for each individual print head.

Based on various kinds of data and signals provided via the parallel input output port 107 on the downstream side, a head control circuit 109k1, 109k2, 109c, 109m, and 109y (referred to collectively as head control circuit 109) controls the print heads by generating signals required to control the print heads such as application of a driving waveform output by the waveform generation circuit 108 for the piezoelectric elements corresponding to respective nozzles of the print head, and transferring of image data output from the image memory 104 by the CPU 101 to each nozzle.

The motor driver 110 and the driver 111 move the first carriage 5a for scanning in the main scanning direction to rotate the transfer roller 15 and transfer the sheet 16 with a predetermined amount by driving and controlling the main scanning motor 8 and the sub-scanning motor 17 according to the driving data provided via the parallel input output port 107 on the downstream side.

Carriage Misalignment

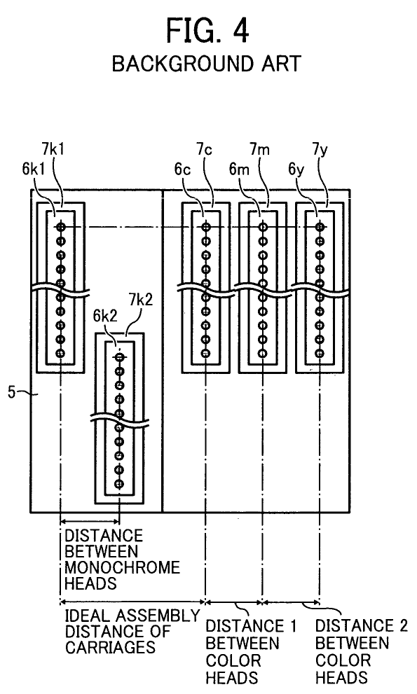

As illustrated in FIG. 4, conventionally, the theoretical relative assembly distance between each print head and the reference head, i.e., the monochrome print head 6k1, is fixed in an integrated carriage 5 having print heads for both monochrome and color ink. Therefore, images are printed by adjusting the print timing with the pixel unit corresponding to the highest resolution power of the encoder based on the carriage speed at printing and the theoretical relative assembly distance.

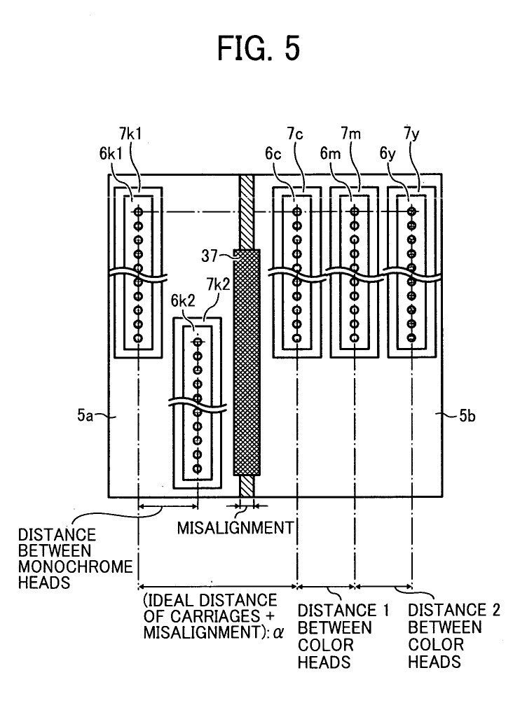

The distance between the monochrome print heads in FIGS. 4 and 5 is the assembly distance between the print head 6k1 and the print head 6k2. A color print head distance 1 is the assembly distance between the print head 6c and the print head 6m. A color print head distance 2 is the assembly distance between the print head 6m and the print head 6y. The theoretical ideal assembly distance between the carriages is the assembly distance between the print head 6k1 and the print head 6c.

However, as illustrated in FIG. 5, in the image forming apparatus of this embodiment the first carriage 5a for monochrome printing and the second carriage 5b for color printing are coupled and also separated by the lock mechanism 37. If color printing is conducted by linking the first carriage 5a and the second carriage 5b having a structure in which the cleaning process such as capping on the sub-system 22 is performed for the second carriage 5b in the case of monochrome printing, misalignment occurs between the carriages 5a and 5b. That is, this misalignment is added to the theoretical ideal distance between the carriages, with the result that the ink may not land on the desired position on the recording medium.

Therefore, the image forming apparatus related to this embodiment is to reduce occurrence of inexact printing (i.e., ejected ink lands away from the desired position) ascribable to the misalignment. Outputs from the first position detection sensor 33a and the second position detection sensor 33b attached to the first carriage 5a and the second carriage 5b, respectively, are read out as unique to each of the two carriages. In addition, by having the first position counter 112a, and the second position counter 112b for counting up and down, the absolute position of each carriage in the main scanning direction can be obtained. Each carriage independently has a print position system (distance from the home position) so that each of the first carriage 5a and the second carriage 5b prints dots at a position determined based on this print position system for the position required by the control unit 100. Therefore, images are printed without an impact caused by the misalignment that occurs when the first carriage 5a and the second carriage 5b are coupled. Therefore, it is possible to prevent the occurrence of the shift between the print position when the first carriage singly scans for monochrome printing and the position when the first carriage 5a and the second carriage 5b scan together for color printing.

Image Formation Method

Print Initial Setting

The print processing (image formation method) of the image forming apparatus in this embodiment is described below.

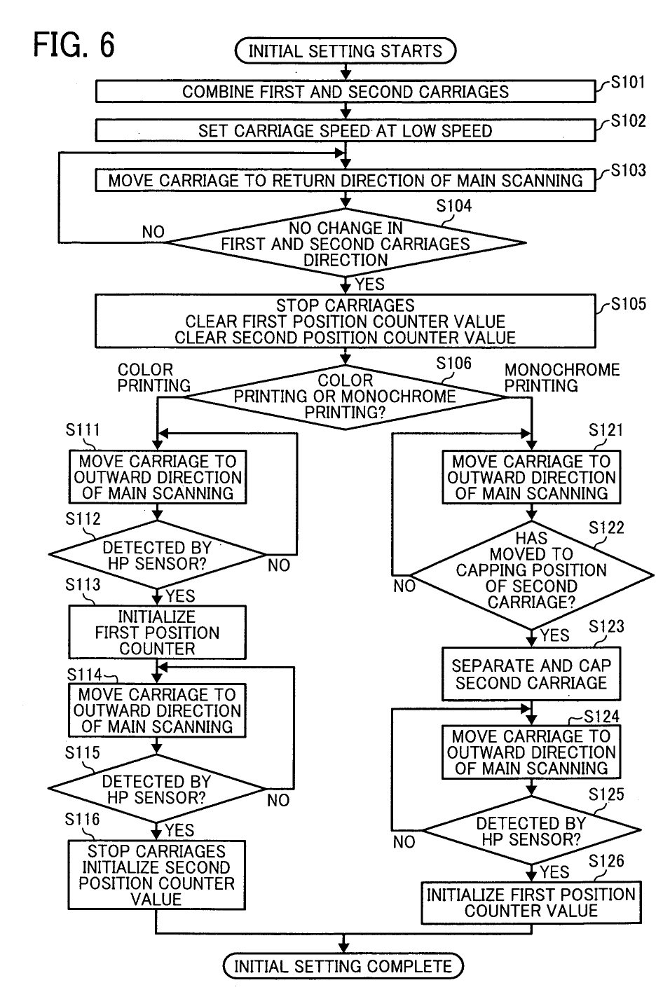

FIG. 6 is a flow chart illustrating the initial printing behavior in the print processing.

First, capping is released and the first carriage 5a and the second carriage 5b (S101) are combined; After linking the carriages, the linked carriages 5a and 5b are moved in the return direction (right direction in FIG. 1) at a predetermined speed not to damage the apparatus; the first carriage 5a and the second carriage 5b are moved until both of the position counter values of the position counters 112a and 112b for the first carriage 5a and the second carriage 5b are unchanged (S102 to S104); The state in which the counter value does not change is that the combined first carriage 5a and the second carriage 5b are pressed against the side plate 2; The counter values of the first position counter 112a and the second position counter 112b are reset in the state in which the combined first carriage 5a and the second carriage 5b are pressed against the side plate 2 (S105); and

when printing is determined as monochrome printing (S106: monochrome printing), the combined carriages 5a and 5b are moved to the position where the second carriage 5b is capped after clearing the counter values of the position counters, the second carriage 5b is separated at the capping position and capped (S121 to S123).

Normally, with regard to the capping positioning, the difference caused by such as misalignment is within the tolerable range, which does not affect the operation.

Next, when only the first carriage 5a is moved in the outward direction (left direction in FIG. 1), the position detection sensor 33a detects the encoder sheet and outputs signals; the first position counter 112a starts counting the signals output by the first detection sensor 33a based on detection of the encoder sheet; The counter value of the first position counter 112a at the time when the closure plate 34a is detected by the home position sensor (HP sensor) 35 (S125) is written as the offset value and the first position counter 112a is initialized (S126); and The offset value is written, for example, a register of the first position counter 112a.

The position counter for each carriage can count down in the minus direction from the initial value when the power is turned on and the carriage is moved in the outward direction.

On the other hand, when printing is determined as color printing (S106: color printing) and the first carriage 5a and the second carriage 5b start moving, the first position detection sensor 33a and the second position detection sensor 33b detect the encoder sheet and output signals; Simultaneously, the first position counter 112a and the second position counter 112b start counting the signals output by the first position detection sensor 33a and the second position detection sensor 33b (S111); The counter value of the first position counter 112a is written as the offset value of the first carriage 5a at the time when the home position sensor 35 detects the closure plate 34a (S112); the first position counter 112a is initialized (S113); the carriage 5a is moved furthermore (S114); The counter value of the second position counter 112b is written as the offset value of the second carriage 5b at the time when the home position sensor 35 detects the closure plate 34b (S115); and the second position counter 112b is initialized (S116).

After initialization of each position counter, each printing position system is established for each carriage. Therefore, the carriages can be stopped at any arbitrary position.

The position counter for each carriage can count down in the minus direction from the initial value when the power is turned on and the carriage is moved in the outward direction.

### Monochrome Printing Behavior

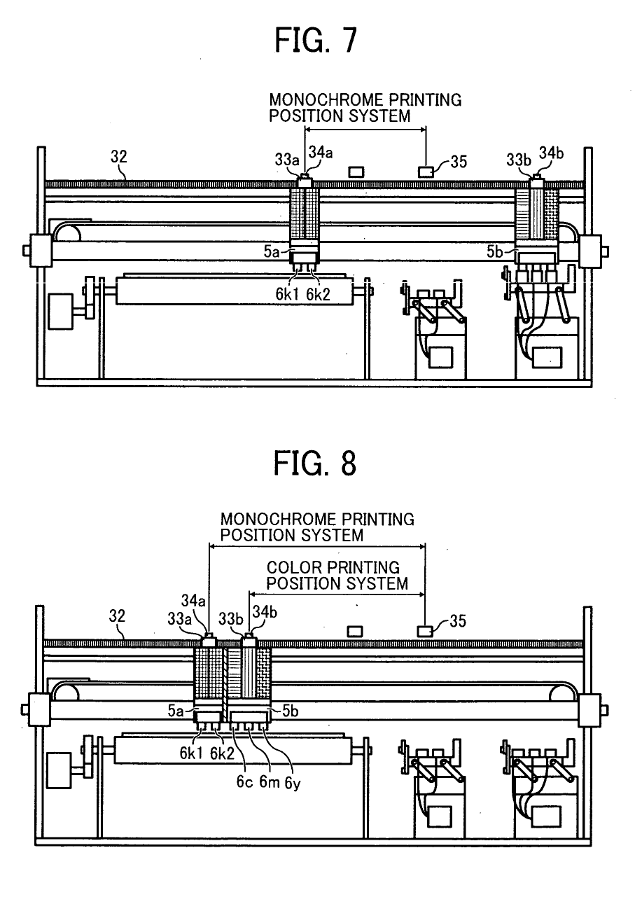

Next, the monochrome printing is described with reference to FIGS. 3 and 7.

As described above, by the initialization (S126) of the first position counter 112a of the first carriage 5a in the initialization behavior, the control unit 100 recognizes the monochrome head printing position system relative to the first carriage 5a.

In this state, in the case of monochrome printing, as illustrated in FIG. 7, the first carriage 5a and the second carriage 5b are separated and the second carriage 5b is capped. Therefore, since the maintenance operation is not necessary during monochrome printing, printing is performed by operating only the first carriage 5a.

In this embodiment, the monochrome reference head 6k1 prints dots checking the print position of the image while referring to the value (¼ unit of the position counter resolution power) counted up every time a rise of the output of A phase from the first position detection sensor 33a of the first carriage 5a is detected.

The print timing can be finely adjusted by using the value of the first position counter 112a of the first carriage 5a of quadrupled frequency.

As illustrated in FIG. 3, once the CPU 101 recognizes a position one before the position where the print head 6k1 starts printing an image, the CPU 101 starts reading the first data group to be printed by the print head 6k1 from the image memory 104, and transfers them to the print head 6k1 via a head control circuit 109k1 for the print head 6k1.

Then, to make a fine adjustment of the ink landing position referring to the next A phase output timing from the first position detection sensor 33a, the CPU 101 outputs a driving waveform from the waveform generation circuit 108k1 for the print head 6k1 at an arbitrary print timing by using the first position counter 112a of the first carriage 5a. By the head control generation circuit 109k1, signals and data required for the other print heads to print images are transferred to conduct the first printing operation.

At the same time, the image data to be printed at the next count position are transferred.

The print head 6k1 does not stop image printing until the first position counter 112a of the first carriage 5a reaches the position count at which the printing is complete by repeating this process.

In addition, as illustrated in FIG. 5, the print head 6k2 is assembled at a position away from the print head 6k1 with a distance A between the monochrome print heads. Therefore, printing is adjusted to meet the monochrome reference head 6k1 by starting the operation of the waveform generation circuit 108k2 for the head 6k2 and the head control circuit 109k2 as described above ahead of the print timing of the reference print head 6k1 with a value corresponding to the distance A for the first position counter 112a of the first carriage 5a.

Therefore, when monochrome printing is performed, the consumption of the ink and the power to maintain the print heads that are not used for printing, and the printing time can be reduced.

### Color Printing Operation

Next, the color printing is described with reference to FIGS. 3 and 8.

As described above, by the initialization (S113 and S116) of the position counter 112a of the first carriage 5a and the position counter 112b of the second carriage 5b in the initialization operation, the control unit 100 recognizes the monochrome printing position system relative to the first carriage 5a, and the color printing position system relative to the second carriage 5b.

From this initialized state, the first carriage 5a and the second carriage 5b are coupled in the case of the color printing as illustrated in FIG. 8, and then printing starts while both carriages are combined.

In this embodiment, the cyan print head 6c as the color reference print head prints an image checking the print position of the image while referring to the value (¼ unit of the position counter resolution power) counted up every time a rise of the output of A phase from the second position detection sensor 33b of the second carriage 5b is detected.

The printing position for color printing can be adjusted by generating the printing timing of the other color print heads 6m and 6y based on the cyan print head 6c.

Since the print control of the print heads for the monochrome printing is performed by using its own monochrome printing position system of the first carriage 5a as described above, the overlapping description is omitted.

As illustrated in FIG. 3, once the CPU 101 recognizes a position one before the position where the cyan print head 6c starts printing an image, the CPU 101 starts reading the first data group printed by the print head 6c from the image memory 104, and transfers the print head 6c via a head control circuit 109c for the print head 6c.

Then, to make a fine adjustment of the ink landing position referring to the next A phase output timing from the second position detection sensor 33b, the CPU 101 outputs a driving waveform from the waveform generation circuit 108c for the print head 6c at an arbitrary print timing by using the second position counter 112b of the second carriage 5b. By the head control generation circuit 109c, signals and data required for the other print heads to print images are transferred to conduct the first printing operation.

At the same time, the image data to be printed at the next count position are also transferred.

The cyan print head 6c does not stop image printing until the second position counter 112b of the second carriage 5b reaches the position count at which the printing is complete by repeating this process.

In addition, as illustrated in FIG. 5, the magenta print head 6m is assembled at a position away from the cyan print head 6c with a distance B (color print head distance 1) between the cyan print head and the magenta print head. Therefore, printing is adjusted to meet the color reference print head 6c by starting the operation of the waveform generation circuit 108m for the magenta print head 6m and the head control circuit 109m as described above ahead of the print timing of the cyan print head 6c with a value corresponding to the distance B for the second position counter 112b of the second carriage 5b.

Similarly, the magenta print head 6m prints an image checking the print position of the image while referring to the value (¼ unit of the position counter resolution power) counted up every time a rise of the output of A phase from the second position detection sensor 33b of the second carriage 5b is detected.

In addition, as illustrated in FIG. 5, the yellow print head 6y is assembled at a position away from the cyan print head 6c with a distance B (color print head distance 1) between the cyan print head and the magenta print head and a distance C (color print head distance 2) between the magenta print head and the yellow print head. Therefore, printing is adjusted to meet the color reference print head 6c by starting the operation of the waveform generation circuit 108y for the yellow print head 6y and the head control circuit 109y as described above ahead of the print timing of the cyan print head 6c with a value corresponding to the distance B and the distance C for the second position counter 112b of the second carriage 5b.

Similarly, the yellow print head 6y prints an image checking the print position of the image while referring to the value (¼ unit of the position counter resolution power) counted up every time a rise of the output of A phase from the second position detection sensor 33b of the second carriage 5b is detected.

As described above, since the first carriage 5a and the second carriage 5b in the image forming apparatus related to this embodiment have the position counters 112a and 112b, respectively, which are initialized separately to have each print position system, the second carriage 5b can print images by referring to value of its own second position counter 112b without adjusting the timing considering the amount corresponding to the misalignment in the case of the color printing.

For example, when the monochrome print head 6k1 prints dots at the position n (n represents any integer) in the main scanning, the first position counter 112a of the first carriage 5a prints dots in the range of the encoder decomposition when the first position counter 112a of the first carriage 5a reaches the count n. To print dots by the cyan print head 6c at the same position, it is suitable to start printing when the second position counter 112b of the second carriage 5b reaches the count n. With regard to the other print heads, it is suitable to start printing by shifting the timing considering the assembled position of each print head relative to each carriage reference print head.

Thus, the occurrence of the print position shift between the monochrome printing position and the color printing position caused by the misalignment of the first carriage and the second carriage can be reduced.

### Second Embodiment

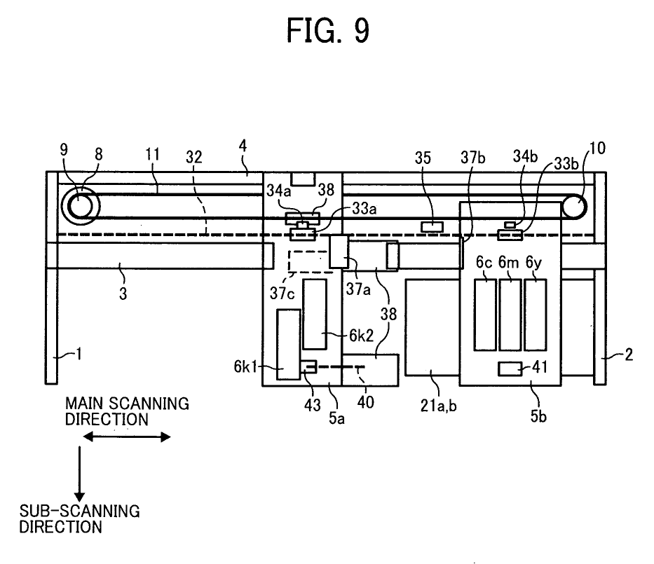

Another (Second) embodiment of the image forming apparatus of the present disclosure is described next with reference to FIGS. 9 to 13.

In this embodiment of the image forming apparatus of the present disclosure, in addition to the structure described above, a relative position encoder sheet 40 is provided to one of the first carriage 5a and the second carriage 5b, and a third position detector (a third position detection sensor 41 and a third position counter 42) is provided to the other of the two carriages. Based on the outputs from the first position detector, the second position detector, and the third position detector, the relative tilt between the first carriage 5a and the second carriage 5b is detected.

The overlapping description between the first and the second embodiments is omitted.

### Structure of Image Forming Apparatus

FIG. 9 is a schematic structure view illustrating the mechanism portion of the ink jet recording apparatus.

In the ink jet recording apparatus illustrated in FIG. 9, in addition to the structure described for the first embodiment, a relative position encoder sheet (a second encoder sheet) 40 is provided to the first carriage 5a, and a third position detection sensor (encoder sensor) 41 is provided to the second carriage 5b.

The relative position encoder sheet 40 is held on a plate 39 by a supporting member 43 such that the relative position encoder sheet 40 is set substantially parallel to the guide rod 3.

The relative position encoder sheet 40 moves into the readable range of the third position detection sensor 41 when the first carriage 5a and the second carriage 5b are combined.

Therefore, by reading the relative position encoder sheet 40 by the third position detection sensor 41, the relative positions of the first carriage 5a and the second carriage 5b can be obtained.

Although the case in which the first carriage 5a has the relative position encoder sheet 40 and the second carriage 5b has the third position detection sensor 41 is described in this embodiment, the reversed embodiment in which the first carriage 5a has the third position detection sensor 41 and the second carriage 5b has the relative position encoder sheet 40 is also suitable considering that the objective of the structure is to detect the relative position of one of the two carriages to the other.

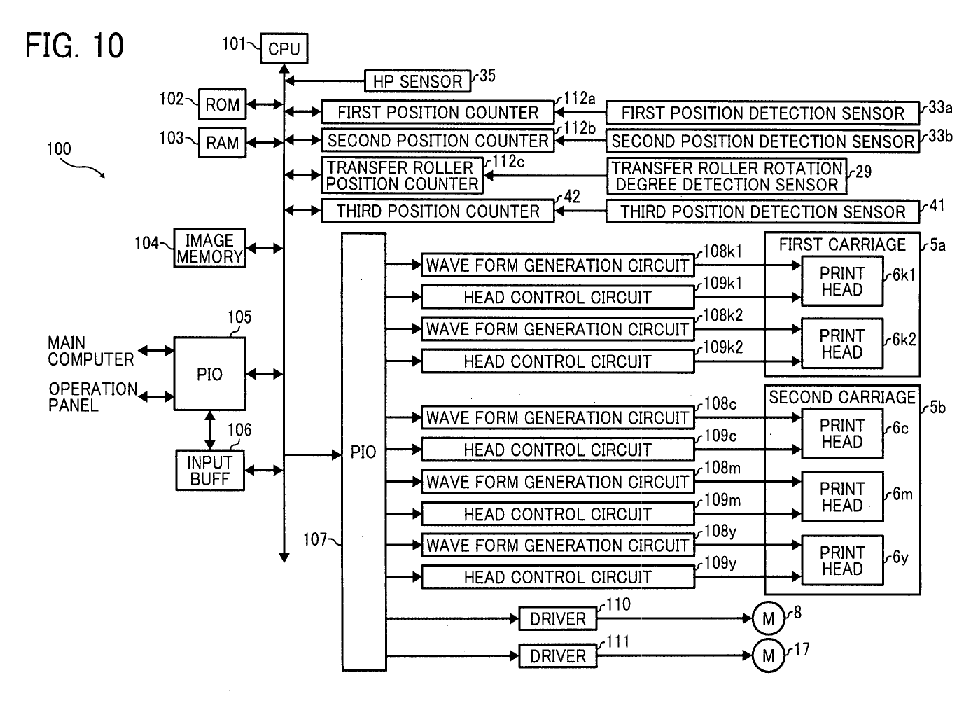

In addition, FIG. 10 is a function block diagram illustrating a control system (control unit) 100 of the image forming apparatus of this embodiment.

In the diagram illustrated in FIG. 10, the CPU 101 processes the output as the reading result of the relative position encoder sheet 40 by the third position detection sensor 41 in addition to the control unit 100 illustrated in FIG. 3.

The third position sensor 42 has the same function as the first position counter 112a.

### Image Formation Method

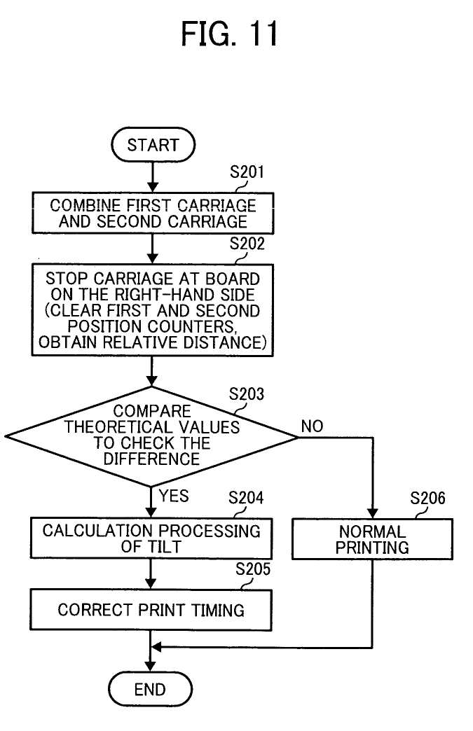

An example of the color printing processing by the image forming apparatus related to this embodiment is described with reference to the flow chart illustrated in FIG. 11.

The overlapping description of the processing of the first and the second embodiments is also omitted.

First, the first carriage 5a and the second carriage 5b are coupled (S201).

Both carriages are coupled such that the first carriage 5a that has finished with the printing operation approaches at a low speed to the second carriage 5b which stands at the home position on the sub-system 21b followed by linking by a linking device 37 having a linking lever 37a, a linking mechanism receiver 37b, a linking driving mechanism 37c, etc.

Next, as described above, the counter values of the first position counter 112a and the second position counter 112b are reset in the state in which the combined first carriage 5a and the second carriage 5b are pressed against the side plate 2.

In addition, the relative distance “a” between the first carriage 5a and the second carriage 5b is obtained by reading the relative position encoder sheet 40 provided to the first carriage 5a by the third position detection sensor 41 provided to the second carriage 5b and stored in a RAM 103 (S202).

The misalignment occurs when both carriages are coupled (S201), and is not usually canceled even when both carriages are pressed against the right side plate 2.

There is no specific limit to the timing of obtaining the relative distance “a”. For example, by obtaining the relative distance “a” at the home position immediately before the printing operation, printing position correction (S205) described later can be conducted based on the relative position just before the printing operation to improve the correction precision.

Next, whether there is a difference between the obtained relative distance “a” and the theoretical (=ideal) value A of the relative distance between the first carriage 5a and the second carriage 5b is determined by comparison (S203).

The theoretical value A can be obtained by, for example, the printed images (i.e., printed results), etc.

If there is a difference (Yes to S203), the tilt calculation processing (S204) described below is performed and printing adjustment is made based on this calculation result of the tilt calculation processing (S204) before actual printing.

On the other hand, if there is no difference, (No to S203), normal printing is performed (S206).

### Tilting Calculation Processing

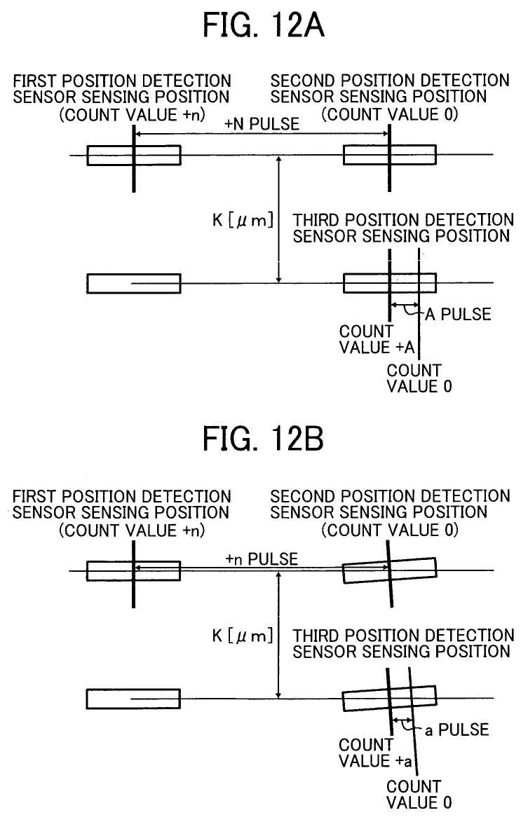

The tilt calculation processing (S204) to calculate the relative tilt of the carriages is described with reference to FIGS. 11 and 12.

FIG. 12A is a diagram illustrating the positional relationship between the first position detection sensor 33a and the second position detection sensor 33b and the positional relationship between the relative position encoder sheet 40 and the third position detection sensor 41 when both carriages are at an ideal position at which three is no tilt relative to the scanning direction (direction perpendicular to the ink ejection direction). FIG. 12B is a diagram illustrating the positional relationship between the first position detection sensor 33a and the second position detection sensor 33b and the positional relationship between the relative position encoder sheet 40 and the third position detection sensor 41 when the second carriage 5b is misaligned relative to the scanning direction.

As illustrated in FIG. 12A, the number of pulses between the sensing position of the first position detection sensor 33a and the sensing position of the second position detection sensor 33b installed onto the coupled carriages is N pulses as ideal.

In addition, the sensed value (count value) by the third position detection sensor 41 is A pulse as ideal from zero count value of the relative position encoder sheet 40.

The distance between the encoder sheet 32 and the relative position encoder sheet 40 is defined as K (μm).

However, when the second carriage 5b is misaligned as illustrated in FIG. 12B, the number of pulses between the sensing position of the first position detection sensor 33a and the sensing position of the second position detection sensor 33b is, for example, +n (n<N) in some cases.

In addition, the sensed value (count value) by the third position detection sensor 41 is, for example, +a (a>A) from zero count value of the relative position encoder sheet 40 in some cases.

Therefore, the variation of the pulse caused by the misalignment between the sensing position of the first position detection sensor 33a and the sensing position of the second position detection sensor 33b is represented as |N−n| by the number of pulses +N at the ideal relationship and the number of pulses +n when the second carriage 5b is misaligned.

Similarly, the variation of the pulse caused by the misalignment at the sensing position by the third position detection sensor 41 is represented as |A−a| by the number of pulses A at the ideal relationship and the number of pulses +a when the second carriage 5b is misaligned.

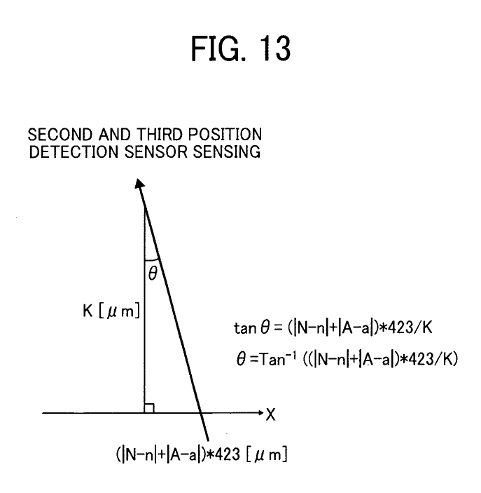

Thus, as illustrated in FIG. 13, the variation of the pulse in the X direction at the relative position encoder sheet caused by tilt of the sensing position direction of the second position detection sensor 33b and the third position detection sensor 41 is represented by (|N−n|+|A−a|).

If the encoder resolution power is 42.3 (μm), the variance distance in the X direction is represented by (|N−n|+|A−a|)×42.3 (μm).

The relative tilt angle θ of the second carriage 5b to the first carriage 5a is represented by the following Relationship (2) according to the Relationship (1):

tan θ=|N−n|+|A−a|×42.3/K Relationship (1)

θ=tan⁻¹(|N−n|+|A−a|)×42.3/K Relationship (2)

By using the thus calculated relative tilt angle θ, degradation of the printed image caused by the variance of the linking accuracy of both carriages at the home position when the carriages are separated can be prevented by correction of the printing position by the ink ejection timing (S206).

There is no limit to the selection of the correction method of the printing position. For example, the printing position can be corrected by shifting the image data for corresponding nozzle by nozzle from the obtained θ based on the nozzle situated at the end on the second position detection sensor 33b with regard to the main scanning direction, and changing the position of the image ejected by the nozzles (for example, making the image data corresponding to the nozzle position in the case of tilt by interpolation) with regard to the sub-scanning direction.

According to the image forming apparatus related to the second embodiment, the relative position of each carriage when the first carriage 5a and the second carriage 5b are coupled can be detected.

In addition, based on the values detected by the first, second and third position detection sensors, and the ideal value obtained by images, etc., the relative tilt angle of the first carriage and the second carriage can be calculated.

Furthermore, based on the obtained relative tilt angle, the variance in printing can be corrected.

Although the first carriage 5a has a recording head that ejects black ink, and the second carriage 5b has color recording heads that eject color ink in the embodiments described above, another embodiment is also suitable in which both of the first carriage 5a and the second carriage 5b eject color ink, or black ink.

This document claims priority and contains subject matter related to Japanese Patent Application no. 2009-266332, and 2010-095941, filed on Nov. 24, 2009, and Apr. 19, 2010, respectively, the entire contents of which are hereby incorporated herein by reference.

According to the present invention, the image quality is improved by reducing the occurrence of print position shift between the print position when the first carriage is singly scanned, and the print position when the first carriage and the second carriage are integrally scanned, which is ascribable to the misalignment of the first carriage and the second carriage when they are coupled.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus comprising:
a first carriage comprising a print head independently movable in a main scanning direction;
a second carriage comprising a print head integrally movable in the main scanning direction together with the first carriage;
an encoder sheet for detecting positions of the first carriage and the second carriage in the main scanning direction;
a first home position reference unit provided to the first carriage;
a second home position reference unit provided to the second carriage;
a home position detector that detects the first home position reference unit and the second home position reference unit;
a first position detector provided to the first carriage, which detects a position of the first carriage by reading the encoder sheet;
a second position detector provided to the second carriage, which detects a position of the second carriage by reading the encoder sheet; and
a control unit comprising a central processing unit that controls ejection of ink from the print head of the first carriage based on an output from the first position detector when the home position detector detects the first home position reference unit, and ejection of ink from the print head of the second carriage based on an output from the second position detector when the home position detector detects the second home position reference unit.

2. The image forming apparatus according to claim 1, wherein when images are printed by moving the first carriage, the first carriage and the second carriage are coupled together and pressed against a stopper provided on a lateral side of the apparatus until outputs of the first position detector and the second position detector are unchanged, and thereafter the outputs of the first position detector and the second position detector are reset, the first carriage is moved to a printable area, and a printing position of the first carriage is initialized when the home position detector detects the first home position reference unit.

3. The image forming apparatus according to claim 1, wherein when images are printed by integrally moving the first carriage and the second carriage together, the first carriage and the second carriage are coupled together and pressed against a stopper provided on a lateral side of the apparatus until outputs of the first position detector and the second position detector are unchanged, thereafter the outputs of the first position detector and the second position detector are reset, the first carriage and the second carriage are together moved to a printable area, a printing position of the first carriage is initialized when the home position detector detects the first home position reference unit, and a printing position of the second carriage is initialized when the home position detector detects the second home position reference unit.

4. The image forming apparatus according to claim 1, wherein one of the first carriage and the second carriage further comprises a relative position encoder sheet that detects a position in the main scanning direction, and the other of the first carriage and the second carriage further comprises a third position detector that reads the relative position of the encoder sheet, and
wherein a relative tilt between the first carriage and the second carriage is detected based on outputs of the first position detector, the second position detector, and the third position detector.

5. The image forming apparatus according to claim 4, wherein printing positions are corrected based on the relative tilt between the first carriage and the second carriage.

6. An image formation method comprising:
moving a first carriage comprising a print head in a main scanning direction;
moving a second carriage comprising a print head integrally in the main scanning direction together with the first carriage;
detecting positions of the first carriage and the second carriage in the main scanning direction by reading an encoder sheet by a first position detector provided to the first carriage, and a second position detector provided to the second carriage, respectively;
detecting a first home position reference unit provided to the first carriage and a second home position reference unit provided to the second carriage by a home position detector; and
controlling ejection of ink from the print head of the first carriage based on an output from the first position detector when the home position detector detects the first home position reference unit and ejection of ink from the print head of the second carriage based on an output from the second position detector when the home position detector detects the second home position reference unit by control unit comprising a central processing unit.

7. A computer-readable recording medium storing a computer program for executing a control method for a recording device, the control method comprising:
moving a first carriage comprising a print head in a main scanning direction;
moving a second carriage comprising a print head integrally in the main scanning direction together with the first carriage;
detecting positions of the first carriage and the second carriage in the main scanning direction by reading an encoder sheet by a first position detector provided to the first carriage, and a second position detector provided to the second carriage, respectively;
detecting a first home position reference unit provided to the first carriage and a second home position reference unit provided to the second carriage by a home position detector; and
controlling ejection of ink from the print head of the first carriage based on an output from the first position detector when the home position detector detects the first home position reference unit and ejection of ink from the print head of the second carriage based on an output from the second position detector when the home position detector detects the second home position reference unit by control unit comprising a central processing unit.
